(19) United States
(12) Patent Application Publication
(10) Pub. No.: US 2018/0015906 A1
(43) Pub. Date: Jan. 18, 2018

(54) Built-in Automobile Washing and Cleaning System

(71) Applicant: Pedro Gimena, West Roxbury, MA (US)

(72) Inventor: Pedro Gimena, West Roxbury, MA (US)

(21) Appl. No.: 15/647,314

(22) Filed: Jul. 12, 2017

Related U.S. Application Data
(60) Provisional application No. 62/362,141, filed on Jul. 14, 2016.

(51) Int. Cl. B60S 1/48; B60S 1/66; B08B 3/02; B60S 1/52; B60S 1/00; B08B 3/00

(52) U.S. Cl. CPC B60S 1/481; B08B 3/02; B60S 1/528; B60S 1/66; B08B 3/00; B60S 1/00

(57) ABSTRACT

An automated vehicle washing and cleaning system which is self-contained within the vehicle and renders the vehicle capable of instantaneous washing without the requirement of stopping at a washing station. The cleaning fluid may be generated via a fluid delivery system, steam clean system or compression system, all of which may be driven by either an electrical or mechanical means, and dispersed via a fluid delivery system.

### CROSS REFERENCE TO RELATED APPLICATION

This application takes the benefit of and claims priority to U.S. Provisional Application Ser. No. 62/362,141 filed on Jul. 14, 2016, the contents of which are herein incorporated by reference.

### BACKGROUND OF THE INVENTION

### Field of the Invention

The present invention relates to a car washing system and more particularly to an automobile washing system which is fully integrated and self-contained within the automobile and utilizes auxiliary systems for washing and cleaning.

### Description of the Related Art

Consumers are normally very meticulous regarding the care and maintenance of their vehicles. Thus, consumers constantly desire to keep their vehicles clean, particularly in areas wherein the vehicles are subject to poor weather conditions, as well as salt and sand. One problem that arises for consumers hinges on the inconvenience involved with having to bring the vehicle to an industrial car wash.

Most often, these car washes are the fully automated type in which an attendant sets the system for the type of vehicle and the type of wash and treatment to be carried out. There are some car systems in which the customer can select his own process. Many of these devices are complicated and expensive, and may require complicated sensors, systems and the like to operate.

While successful and well accepted, these known car wash systems have a drawback in that the vehicle owner must bring his vehicle to the car wash, wait in line, and pay a premium to have the car washed. Many people simply choose not to have their car washed rather than put up with the inconveniences and cost.

An alternative to having a car washed in such an automated environment is to simply wash the car at home, and many people opt for this approach. However, washing the car at home, while overcoming the above-stated problems associated with the automated car wash systems, presents some problems of its own.

Typically, a homeowner a garden hose, with or without attachments at the end thereof, to wash the vehicle. A common problem encountered in this manner is that the hose becomes caught underneath one of the tires or a lower portion of the body of the vehicle, and the owner must free the hose from such obstacle, by either retracing his steps backwards or flinging the hose violently to free the hose from the obstruction. Of course, this can be a source of aggravation, is time consuming, and in some instances can actually damage the car.

Attempts have been made to overcome the problems associated with manually washing a car at home, while still providing benefits associated with automated car washing machines. For example, concurrent art discloses portable car wash systems wherein an elongated section of perforated hose is attached to a top of a car. While wetting a substantial portion of the car simultaneously, with or without detergent, this device presents various drawbacks. A second garden hose, or the like, would be required to wash the car as the cascading effect of the water emitted from the closed-end hose would still require pressure washing at various points of the car. Such systems would require moving, reconfiguration and thus are not automated, and can be burdensome in the assembly end.

Additional concurrent systems utilize a portable vehicle washing device. However, in this case, sections of rigid tubing having perforations therein form a circular halo positioned above the roof of the car, while an elongated T-section is draped on either side of the car. Once again, a second garden hose would likely be required in order to adequately wash the car using a hand-held nozzle or the like. Furthermore, this assembly presents the same disadvantages of impeding access to all points of the vehicle being washed. Furthermore, this particular device requires setup, breakdown, and storage which is inconvenient to the homeowner.

Accordingly, there is a continuing need for an assembly for manually washing a vehicle which substantially prevents the hose from becoming obstructed by a tire or lower portion of the vehicle or getting a kink therein while washing the vehicle. Such an as should be fairly simple to operate and provide maximum access to the vehicle being washed. Moreover, the assembly should not impede access to the vehicle being washed, and should be fairly small so as to be portable and easily stored. The present invention fulfills these needs and provides other related advantages.

### SUMMARY OF THE INVENTION

The instant apparatus and system, as illustrated herein, is clearly not anticipated, rendered obvious, or even present in any of the prior art mechanisms, either alone or in any combination thereof. A versatile system, method and series of apparatuses for creating and utilizing an internally disposed, self-contained and automated vehicle cleaning system is disclosed.

It is an object of the present system to introduce the concept of an integrally fitted automated vehicle cleaning system within the vehicle itself.

It is an object of the present system to introduce the concept of an integrally fitted automated vehicle exterior cleaning system within the vehicle itself.

It is an object of the present system to introduce the concept of an integrally fitted vehicle interior cleaning system within the vehicle itself.

It is an object of the present system to introduce the concept of an integrally fitted automated vehicle exterior cleaning system comprising a brushless mechanism including but not limited to a fine cloth system that may utilized for cleaning the vehicle.

It is an object of the present system to introduce the concept of an integrally fitted automated vehicle exterior cleaning system comprising a touch free system comprising high pressure water to clean and air drying equipment.

It is an object of the present system to introduce the concept of an integrally fitted automated vehicle exterior cleaning system comprising modern “foam” washing wheels made of closed cell foam.

In operation, the automated vehicle washing and cleaning system 10 in some embodiments, defines the following set of processes:

### 1. Pre-Wash/Soap Up Process:

The vehicle may be sprayed with water from a series of delivery nozzles via a fluid delivery system to wet the vehicle and remove loose dirt, dust as well as break down any grime. Then, a quantity of washing and/or cleaning fluid may be dispersed on the vehicle via a fluid generation system and a curtain system may move back and forth along the length of the car, rinsing and lathering the surface.

### 2. Scrub Process:

Subsequent to the Pre-Wash/Soap Up process, the vehicle will proceed through a set of built-in scrubbers which are vertical poles with cloth strips that move at high speed and lash against the car cleaning it in the process.

3. Rinse Process:

The vehicle will go through a rinse cycle where water is sprayed one more time to remove any last traces of the vehicle's dirt and soap residues. This removes trace deposits of soap and cleaning solution that might have stayed on the surface.

4. Wax & Dry Process:

The vehicle may finally goes through a wax process where various protective waxes are sprayed with a low pressure system for an evening coating and then scrubbed lightly to get a glow out from the surfaces. In addition, the car at the last step is heated pressurize pole dryer which evaporates water still on the surface.

In practice, if the user desires to only wash the vehicle, the user may press a button labeled AUTOMATIC and it will operate in an automated manner under the process above. The tanks for material use in washing are built in the space of the rear trunk. Water tank holds up to 30 gallons of water, the soap and cleaning solution is a half of a gallon and the wax is another half of a gallon.

Disclosed is a vehicle capable of self-washing by the driving force of the vehicle. An air compressor for generating air flow and a steam generation device are installed to operate by the accessory power of the vehicle's engine. Inhalation and discharge holes are formed for inhaling and discharging air, and a separate vacuum accessory or injector may be combined to the hole, selectively. Thus, only a small amount of water is required for washing the car by steam without a cleansing solution, thereby eliminating wasted water and preventing environmental pollution together with no restriction of washing space. Time and costs are reduced compared to conventional washing. In winter, the steam generation device allows washing without water freezing, and ensures sufficient visibility for safe driving by eliminating frost. The vacuum accessory may be used for cleaning the inside of the car, so a user may always maintain the car clean and optimize car functions

These together with other objects of the apparatus, along with the various features of novelty, which characterize the mechanism, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

The invention may be more completely understood in consideration of the following detailed description of various embodiments of the invention in connection with the accompanying drawings, in which:

FIG. 1 illustrates one embodiment of an automated vehicle washing and cleaning system with a trunk mounted fluid delivery system in an operational position.

FIG. 2 illustrates one embodiment of a fluid generation system which may be located in either a trunk or engine compartment for use in the automated washing and cleaning system.

FIG. 3 illustrates one embodiment of the automated vehicle washing and cleaning system displaying both the fluid delivery system and the fluid generation system.

FIG. 4 illustrates one embodiment of the automatic vehicle washing and cleaning system with a series of delivery nozzles located throughout the vehicle.

FIG. 5 illustrates an alternative fluid delivery system located on the roof of the vehicle in the operational position with a series of delivery nozzles located throughout the vehicle.

FIG. 6 illustrates one embodiment of the automated vehicle washing and cleaning system with the fluid delivery system and the series of delivery nozzles.

### DETAILED DESCRIPTION OF THE SEVERAL EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

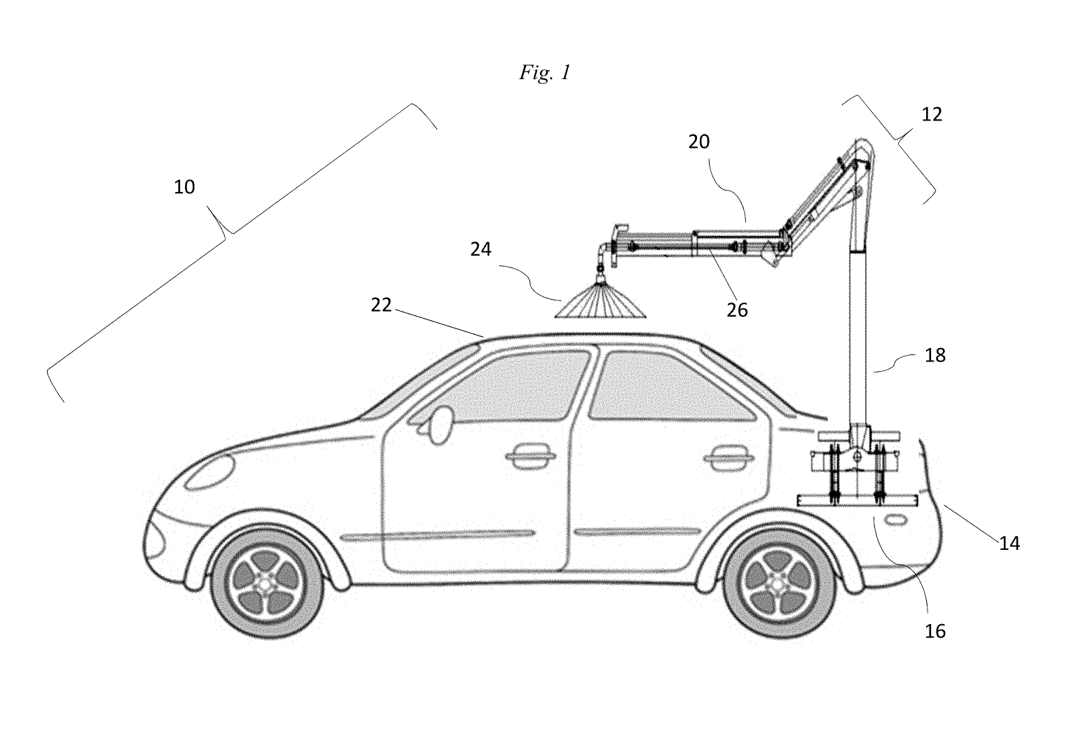

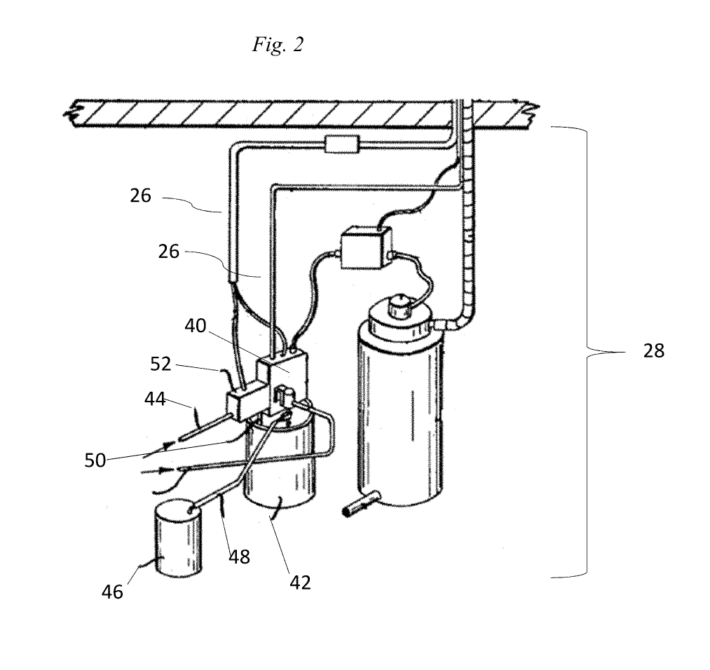

FIG. 1 illustrates one embodiment of an automated vehicle washing and cleaning system 10, wherein a fluid delivery system 12 is preferably located within a trunk portion 14 of the vehicle. In operation the fluid delivery system 12, includes a base 16 which may be mounted and/or secured within the trunk portion 14 to allow for deployment when in operation. The fluid delivery system 12 further includes a first arm 18 which extends from the base 16, and a second arm 20, wherein the second arm 20 is connected to the first arm 18 and extends outwardly from the first arm 18 and preferably over a roof portion 22 of the vehicle. Preferably a spray apparatus 24 is attached to one end of the second arm 20 to deliver a quantity of washing and/or cleaning fluid over the vehicle when the automated vehicle washing and cleaning system 10 is in use. Additionally, a piping system 26 located within the fluid delivery system 12 is in communication with a fluid generation system 28 (see FIG. 2) in order to disperse the quantity of washing and/or cleaning fluid over the vehicle.

FIG. 2 illustrates the fluid generation system 28, wherein the fluid generation system 28 may comprise several components, the function of which in unity, is to bring a quantity of washing and/or cleaning fluid to the fluid delivery system 12 via the piping system 26, such as fresh water, to some external portion of the vehicle. In one embodiment, the fluid generation system 28 may comprise a compression system or a pressure based washing system, both of such systems as known in the fluid movement arts.

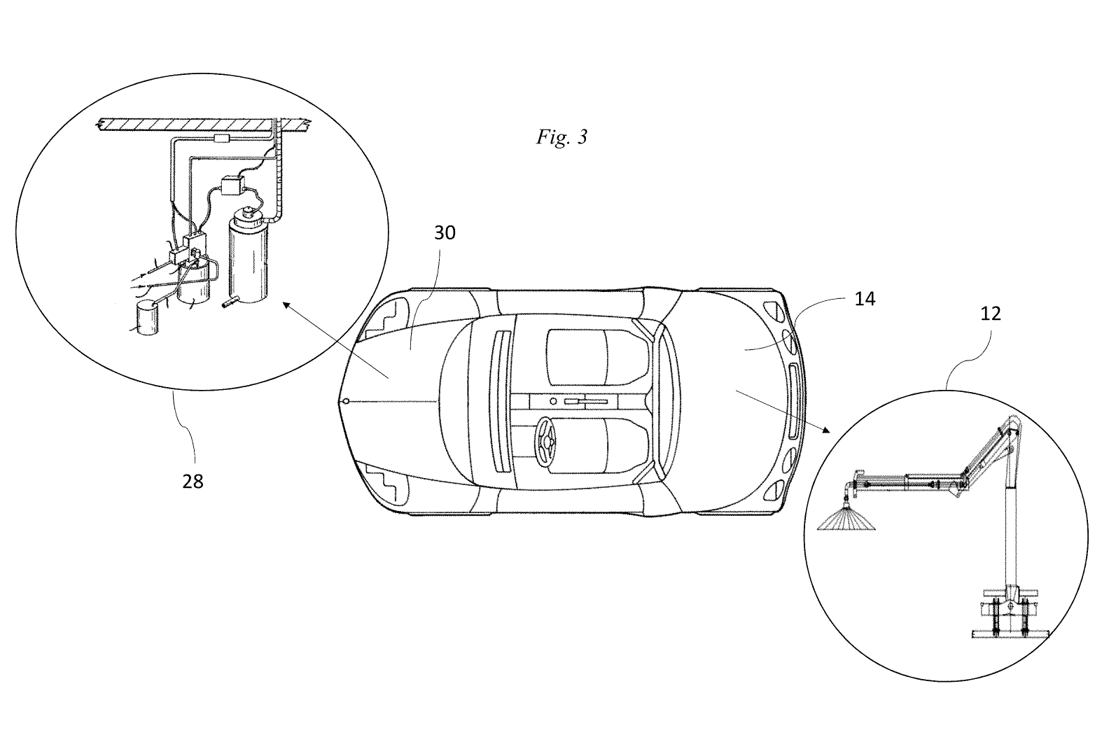

Additionally, in a preferred embodiment, the fluid generation system 28 may be housed within an engine compartment 30 (see FIG. 3) or the trunk portion 14 of the vehicle within a protective compartment and not exposed to outside elements and/or the human eye unless the compartment is uncovered.

The fluid generation system 28 is designed to be in fluid communication with the fluid delivery system 12 to deliver cleaning fluids and solutions, in numerous combinations, for cleansing of the exterior of a vehicle. The fluid delivery system 28 may exit the internal portion of the vehicle at any number of areas, including the truck and the roof of a vehicle.

In one embodiment, utilizing a typical steam, compression or water pumping system, the fluid generation system 28 may comprise a water pump 40 which is connected to a cleaning solution tank 42 by a conduit 44. Preferably, the cleaning solution tank 42 is utilized for storing the quantity of washing and/or cleaning fluid to be eventually dispersed over the vehicle by the fluid delivery system 12. In this embodiment, a quantity of washing and/or cleaning fluid may be located in a fluid container 46, and is drawn through a tube 48 into the cleaning solution tank 42 via the water pump 40. The piping system 26 allows for fluid communication between the fluid generation system 28 and the fluid delivery system 12. In this embodiment, the piping system 26 allows for the quantity of washing and/or cleaning fluid to be pumped from the cleaning solution tank 26 to be dispersed through the spray apparatus 24.

Additionally, a cleaning solution tank outlet 50, which extends into the cleaning solution tank 42 is also connected to the water pump 40 through a valve assembly 52. In operation, the valve assembly 52 is disposed to provide the quantity of washing and/or cleaning fluid to the water pump 40. In one embodiment, the valve assembly 52 includes a known in the art solenoid valve assembly to open and close the water pump 40 in response to an electrical signal.

In one embodiment the valve assembly 52 are operated by a switch (not shown) wherein in operation, a user may depress the switch to engage the fluid generation system 28 thereby pumping the quantity of washing and/or cleaning fluid through the piping system 26 to the fluid delivery system 12 and finally being dispersed through the spray apparatus 24.

FIG. 3 illustrates one embodiment of the automated vehicle washing and cleaning system 10 wherein the fluid delivery system 12 is located in the trunk portion 14 of the vehicle and the fluid generation system 28 is located in the engine compartment 30 of the vehicle.

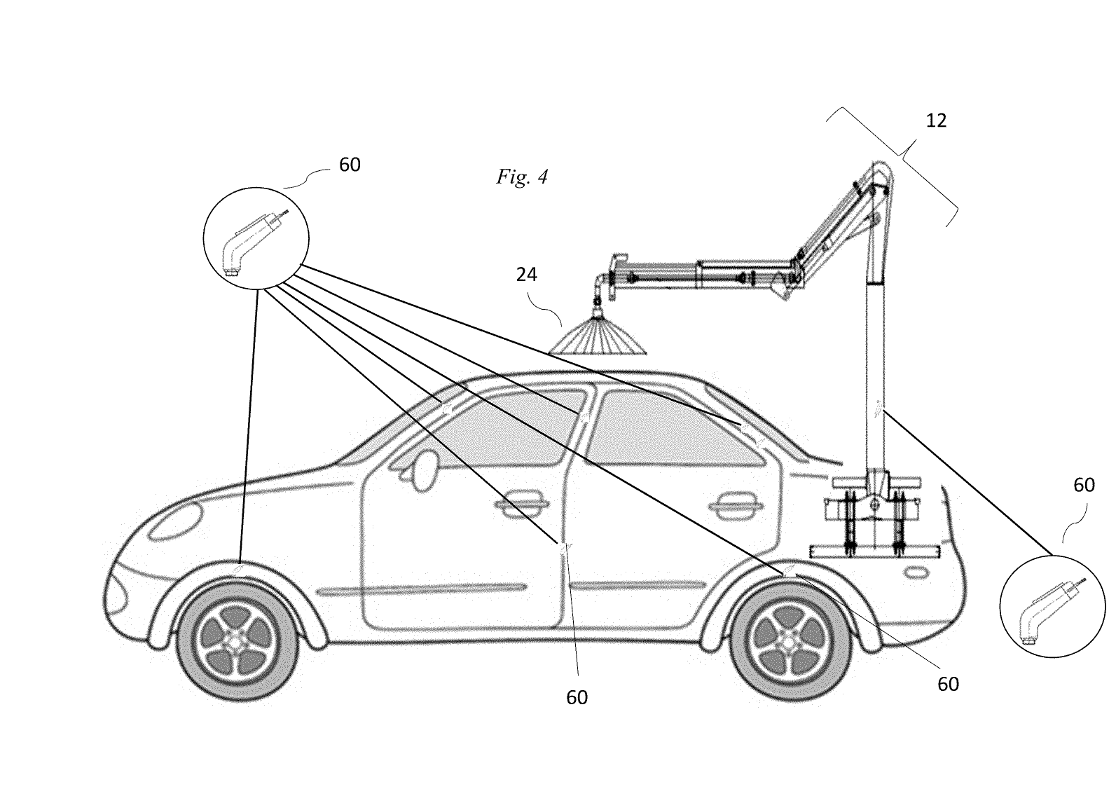

FIG. 4 illustrates another embodiment of the automated vehicle washing and cleaning system 10, wherein a series of delivery nozzles 60 are located throughout the vehicle. In this embodiment, the series of delivery nozzles are in fluid communication with the fluid generation system 28 via the piping system 26 to further disperse the quantity of washing and/or cleaning fluid over the vehicle in conjunction with the fluid delivery system 12.

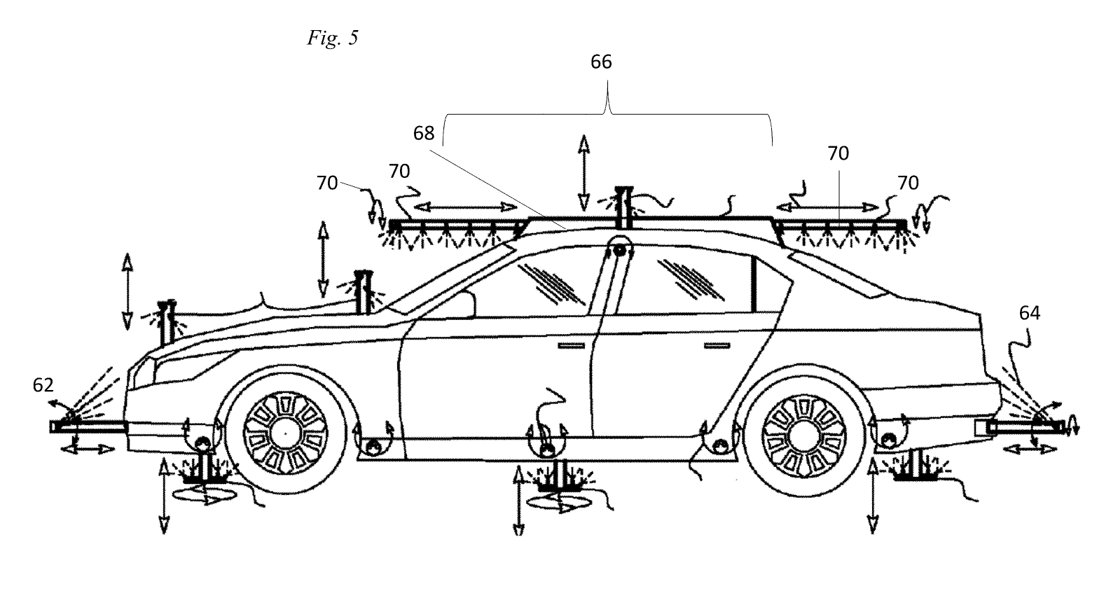

FIG. 5 illustrates yet another embodiment of the automated vehicle washing and cleaning system 10, wherein a front nozzle 62 and a rear nozzle 64 are located on a front and a rear bumper of the vehicle respectively. Additionally, a secondary fluid delivery system 66 may be located on a roof portion 68 of the vehicle, wherein the secondary fluid delivery system 66 includes a set secondary delivery nozzles 70 to further dispense the quantity of washing and/or cleaning fluid from via the piping system 26.

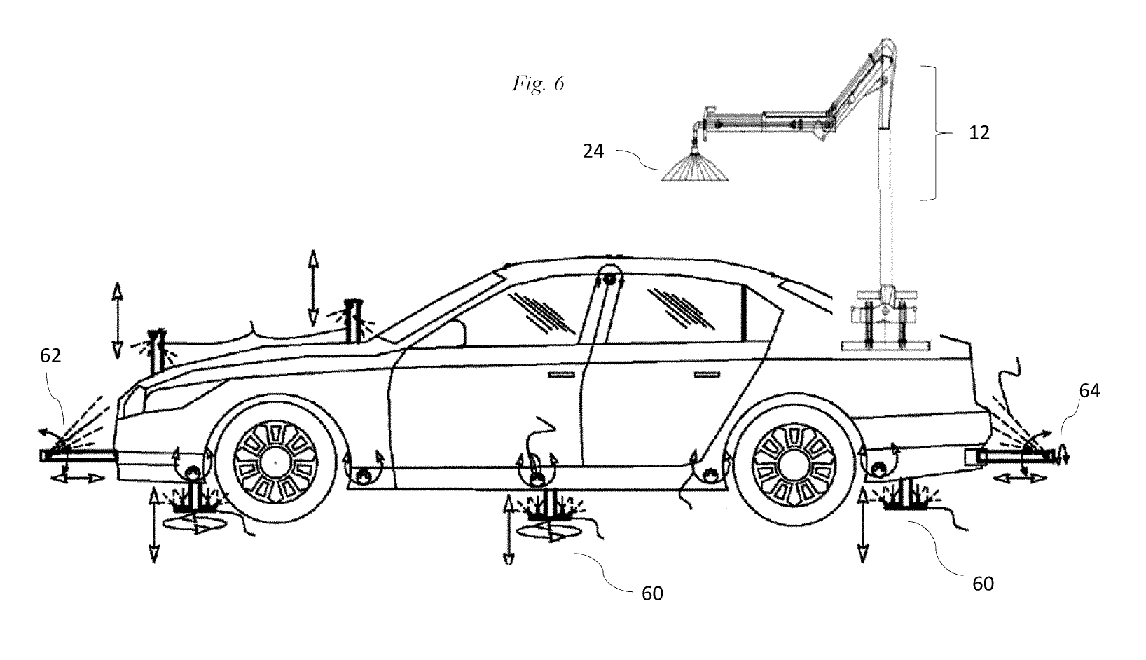

FIG. 6 illustrates yet another embodiment of the automated vehicle washing and cleaning system 10, wherein the fluid delivery system 12 is shown in the trunk portion 14 with both the series of delivery nozzles 60, along with the front nozzle 62 and the rear nozzle 64 in operation.

Furthermore, the automated vehicle washing and cleaning system 10 comprises many economic advantages, including better water consumption efficiency as the system is disposed to consume 20-30 gallons of water, unlike the 60-70 gallons of water consumed at a typical car wash. Not only is water being saved, electricity and power consumption is less that the consumption of the car washing outlet as the system may utilize auxiliary power from the vehicle engine.

Additionally, it is estimated that the system may also cut washing time by at least 33% which allows the system to operate in a cost-effective manner and is the best possible option for washing the least amount of water in reaching goals to clean and wash a vehicle.

What is claimed is:

1. An automated vehicle washing and cleaning system comprising:
a fluid delivery system, wherein the fluid delivery system is located in a trunk portion of the vehicle; and
a fluid generation system, wherein the fluid generation system is located in an engine compartment of the vehicle.

2. The automated vehicle washing and cleaning system of claim 1 wherein the fluid delivery system comprises:
a base, wherein the base is secured with the trunk portion;
a first arm, wherein the first arm extends from the base;
a second arm, wherein the second arm is connected to the first arm and extends outwardly from the first arm over a roof portion of the vehicle; and
a spray apparatus attached to one end of the second arm to deliver a quantity of washing and/or cleaning fluid over the vehicle when the system is in use.

3. The automated vehicle washing and cleaning system of claim 2 wherein the fluid delivery system further comprises:
a piping system located within the fluid delivery system and in communication with the fluid generation system in order to disperse the quantity of washing and/or cleaning fluid over the vehicle.

4. The automated vehicle washing and cleaning system of claim 1, wherein the fluid generation system comprises:
a water pump;
a cleaning solution tank, wherein the cleaning solution tank is connected to the water pump by a conduit;
a fluid container, wherein the fluid container stores a quantity of washing and/or cleaning fluid;
a tube, wherein the tube connects the fluid container into the cleaning solution tank;

5. The automated vehicle washing and cleaning system of claim 4, wherein the fluid generation system further comprises:
a cleaning solution tank outlet, wherein the cleaning solution tank outlet extends into the cleaning solution tank; and
a valve assembly, wherein the cleaning solution tank is connected to the water pump via the valve assembly.

6. The automated vehicle washing and cleaning system of claim 1, wherein the system further comprises:
a series of delivery nozzles located throughout the vehicle;
wherein the series of delivery nozzles are in fluid communication with the fluid delivery system.

7. The automated vehicle washing and cleaning system of claim 1, wherein the system further comprises:
a front nozzle located on a front bumper of the vehicle; and
a rear nozzle located on a rear bumper of the vehicle.

8. The automated vehicle washing and cleaning system of claim 1, wherein the system further comprises:
a secondary fluid delivery system located on a roof portion of the vehicle, wherein the second fluid delivery system further comprises:
a set of secondary delivery nozzles.

9. An automated vehicle washing and cleaning system comprising:
a fluid delivery system, wherein the fluid delivery system is located in a trunk portion of the vehicle and comprises:
a base, wherein the base is secured with the trunk portion;
a first arm, wherein the first arm extends from the base;
a second arm, wherein the second arm is connected to the first arm and extends outwardly from the first arm over a roof portion of the vehicle;
a spray apparatus attached to one end of the second arm to deliver a quantity of washing and/or cleaning fluid over the vehicle when the system is in use; and
a piping system located within the fluid delivery system and in communication with the fluid generation system in order to disperse the quantity of washing and/or cleaning fluid over the vehicle;
a fluid generation system, wherein the fluid generation system is located in an engine compartment of the vehicle, wherein the fluid generation system comprises:
a water pump;
a cleaning solution tank, wherein the cleaning solution tank is connected to the water pump by a conduit;
a fluid container, wherein the fluid container stores a quantity of washing and/or cleaning fluid;
a tube, wherein the tube connects the fluid container into the cleaning solution tank;
a cleaning solution tank outlet, wherein the cleaning solution tank outlet extends into the cleaning solution tank; and
a valve assembly, wherein the cleaning solution tank is connected to the water pump via the valve assembly;
a series of delivery nozzles located throughout the vehicle, wherein the series of delivery nozzles are in fluid communication with the fluid delivery system;
a front nozzle located on a front bumper of the vehicle;
a rear nozzle located on a rear bumper of the vehicle;
a secondary fluid delivery system located on a roof portion of the vehicle, wherein the second fluid delivery system further comprises:
a set of secondary delivery nozzles; and
wherein the fluid generation system is in fluid communication with the fluid delivery system to bring a quantity of washing and/or cleaning via the piping system and to be dispersed through the spray apparatus, series of delivery nozzles, front nozzle, rear nozzle, and the set of secondary delivery nozzles.
